(19) United States
(12) Patent Application Publication
(10) Pub. No.: US 2026/0052299 A1
(43) Pub. Date: Feb. 19, 2026

(54) APPARATUS AND METHOD OF CUSTOMIZED INFORMATION PROVIDING USING FINGERPRINT INFORMATION OF CONTENTS

(71) Applicant: Seong Jung KIM, Busan (KR)

(72) Inventor: Seong Jung KIM, Busan (KR)

(21) Appl. No.: 19/298,196

(22) Filed: Aug. 13, 2025

(30) Foreign Application Priority Data
Aug. 16, 2024 (KR) 10-2024-0109548

(51) Int. Cl. H04N 21/8545; G06V 10/70; H04N 21/81

(52) U.S. Cl. CPC H04N 21/8545; G06V 10/70; H04N 21/812

(57) ABSTRACT

An apparatus and method for providing a customized service using content fingerprint information are disclosed. In an apparatus for providing a customized service using content fingerprint information, a customized service providing apparatus according to one embodiment includes a processor and a memory storing instructions executable by the processor, wherein the processor may receive, from a user terminal of a user to be provided with the customized service, an image including content and service information requested by the user, identify the content from the image based on fingerprint information generated corresponding to the content in order to identify the content, acquire meta information corresponding to a frame constituting the content based on the image, and provide the service requested by the user based on the meta information.

### CROSS-REFERENCE TO RELATED APPLICATION

This application claims priority to and the benefit of Korean Patent Application No. 10-2024-0109548, filed on Aug. 16, 2024, the disclosure of which is incorporated herein by reference in its entirety.

### BACKGROUND

### Technical Field

The following description relates to an apparatus and a method for providing a customized service using content fingerprint information.

### Description of Related Art

Recently, streaming services have been continuously expanding. Online video streaming services are expected to further grow in the future, as improvements in Internet speed and the widespread use of mobile devices allow more users to view online video content.

The markets for virtual reality (VR) and augmented reality (AR) provide new dimensions to the content industry, while artificial intelligence (AI) and big data technologies are expected to be applied to various areas of the content industry such as personalization and recommendation systems, content analysis, and user experience enhancement.

In addition, live streaming platforms and interactive content are expected to play important roles in providing users with more direct and immersive experiences.

Already, a vast number of consumers are enjoying the search and consumption of information through content. Accordingly, there is a growing demand for solutions capable of providing information and products associated with the content in a customized manner.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The embodiments disclosed herein are directed to providing a technology for offering a customized service using content fingerprint information.

However, the technical problem to be solved is not limited to the foregoing, and other technical challenges and improvements may also be addressed within the scope of the present disclosure.

In accordance with one embodiment, there is provided an apparatus for providing a customized service using content fingerprint information.

The customized service providing apparatus comprises a processor, and a memory storing instructions executable by the processor.

The processor is configured to receive, from a user terminal of a user to be provided with the customized service, an image including content and service information requested by the user; identify the content from the image based on fingerprint information generated corresponding to the content in order to identify the content; acquire meta information corresponding to a frame constituting the content based on the image; and provide the service requested by the user based on the meta information.

The fingerprint information may include at least one of a still cut of the content, a pixel distribution of a frame constituting the content, an outline of the frame, a shape of an object included in the frame, a size of the frame, or a variation trend of data amount of the frame over time of the content, and the pixel distribution may include a brightness and RGB distribution of pixels.

The processor may calculate at least one of a degree of matching between the image and the pixel distribution of the frame, a degree of matching between the image and the outline of the frame, a degree of matching between the image and the shape of an object included in the frame, or a degree of matching between the image and a variation trend of data amount of the frame over time, and identify the content based on whether at least one of the degrees of matching is equal to or greater than a predetermined degree of matching.

The meta information may include at least one of a shooting location of the frame of the content, a title of the content, a producer of the content, a playback time of the content, a resolution of the content, a file size, playback progress of the content, person information included in the frame, or product information included in the frame.

The processor may obtain modified information derived from an original of the content based on the meta information, and provide the modified information to the user in response to the service information requested by the user. The modified information may include at least one of editing information of an image of the original, editing information of subtitles corresponding to the original, editing information of an audio signal of the original, or information indicating whether the image is an original.

The processor may determine whether the image is a part of an original content based on the meta information in response to the service information requested by the user, and determine whether the image constitutes a copyright infringement based on whether the image is a part of the original content.

The processor may identify whether an advertiser or a copyright holder associated with the service information requested by the user exists, and allocate a predetermined revenue to the advertiser or the copyright holder when the advertiser or the copyright holder exists.

According to the embodiments described herein, the customized service providing apparatus may support users in easily acquiring information related to content by providing a customized service using content fingerprint information.

Through the provision of information associated with the content, the embodiments may enhance user convenience and allow copyright holders and advertisers associated with the content to more easily obtain revenue.

In addition to the above, various additional effects directly or indirectly derivable from the disclosure of this specification may also be provided.

Other features and aspects will be apparent from the following detailed description, the drawings, and the claims.

### BRIEF DESCRIPTION OF THE DRAWINGS

FIG. 1 is a schematic block diagram illustrating a customized service providing system according to one embodiment.

FIG. 2 is a schematic block diagram illustrating a customized service providing apparatus according to one embodiment.

FIG. 3 is a diagram illustrating a process of generating content fingerprint information of an image according to one embodiment.

FIG. 4 is a diagram illustrating an operation of identifying a playback point of content based on generated fingerprint information according to one embodiment.

FIG. 5 illustrates an example of a variation trend of data values for respective frames.

FIGS. 6 and 7 are diagrams illustrating an operation of determining whether a copyright infringement has occurred by the customized service providing apparatus illustrated in FIG. 1.

FIG. 8 illustrates an example of services provided by the customized service providing apparatus illustrated in FIG. 1.

FIGS. 9 and 10 are diagrams illustrating a process in which the customized service providing apparatus illustrated in FIG. 1 allocates revenue to an advertiser or a copyright holder.

FIG. 11 illustrates an example of a service providing operation of the customized service providing apparatus illustrated in FIG. 1 when additional information related to content is stored.

FIG. 12 illustrates an example of a service providing operation of the customized service providing apparatus illustrated in FIG. 1 when additional information related to content is not stored.

FIG. 13 illustrates an example of a synchronization service provided by the customized service providing apparatus illustrated in FIG. 1.

FIG. 14 illustrates another example of a synchronization service provided by the customized service providing apparatus illustrated in FIG. 1.

FIG. 15 illustrates yet another example of a synchronization service provided by the customized service providing apparatus illustrated in FIG. 1.

FIG. 16 illustrates an example of a service of providing product information by the customized service providing apparatus illustrated in FIG. 1.

FIG. 17 is a diagram illustrating an operation in which the customized service providing apparatus illustrated in FIG. 1 provides a service in association with a playback device.

FIG. 18 is a diagram illustrating a process in which the customized service providing apparatus illustrated in FIG. 1 generates service information associated with content.

FIG. 19 is a diagram illustrating an operation in which different input interfaces are provided depending on types of users.

FIGS. 20 and 21 are diagrams illustrating an operation in which fingerprint information and meta information are updated through a plurality of users.

FIG. 22 is a diagram illustrating an operation in which the customized service providing apparatus illustrated in FIG. 1 supports playback of content.

FIG. 23 is a diagram illustrating an example of a method for managing service information by the customized service providing apparatus illustrated in FIG. 1.

FIG. 24 is a flowchart illustrating an operation of a content expansion apparatus illustrated in FIG. 1.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following structural or functional descriptions of examples are merely intended for the purpose of describing the examples and the examples may be implemented in various forms. Here, examples are not construed as limited to the present disclosure and should be understood to include all changes, equivalents, and replacements within the idea and the technical scope of the present disclosure.

Although terms of “first” or “second” are used to explain various components, the components are not limited to the terms. These terms should be used only to distinguish one component from another component. For example, a “first” component may be referred to as a “second” component, and similarly the “second” component may also be referred to as the “first” component.

It will be understood that when a component is referred to as being “connected to” another component, the component can be directly connected or coupled to the other component or intervening components may be present.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms used herein including technical or scientific terms have the same meanings as those generally understood consistent with and after an understanding of the present disclosure. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

The term “unit” or the like used herein may refer to a software or hardware component, such as a field-programmable gate array (FPGA) or an application-specific integrated circuit (ASIC), and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the examples will be described in detail with reference to the accompanying drawings. When describing the examples with reference to the accompanying drawings, like reference numerals refer to like components and any repeated description related thereto will be omitted.

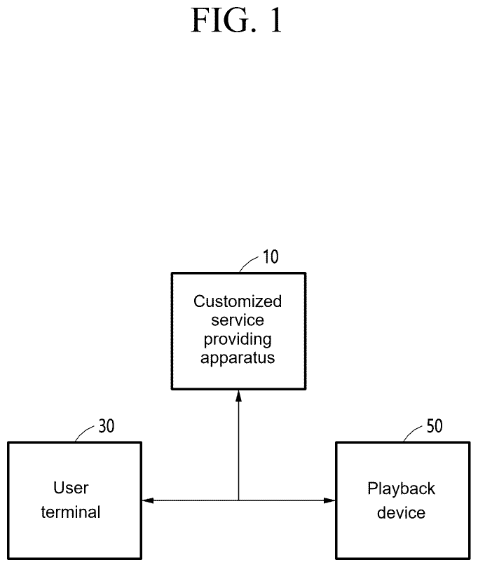

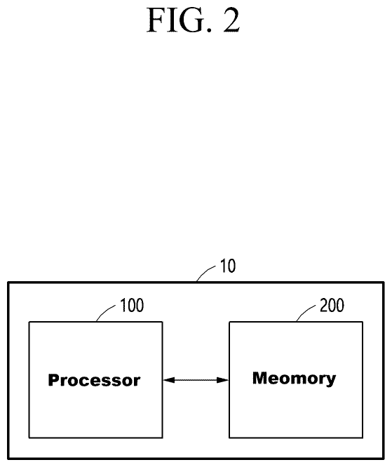

FIG. 1 is a schematic block diagram illustrating a customized service providing system according to one embodiment, and FIG. 2 is a schematic block diagram illustrating a customized service providing apparatus according to one embodiment.

Referring to FIGS. 1 and 2, a customized service providing apparatus 10 may provide a customized service requested by a user in response to a service request received with respect to certain content.

The term content may refer to an intangible result embodied in a medium in which cultural materials are specifically processed. The content may include visual content and auditory content. The visual content may include videos or images, and the video may consist of a plurality of frames, each of which may be implemented as an image.

The customized service may include providing information related to the content, modifying or editing the content, a replay service, subtitle provision, shopping information related to the content, a codec for playing the content, and/or provision of other content associated with the content.

The customized service providing apparatus 10 may be implemented as a printed circuit board such as a motherboard, an integrated circuit (IC), or a system-on-chip (SoC). The customized service providing apparatus 10 may also be implemented as an application processor.

In addition, the customized service providing apparatus 10 may be implemented within a personal computer (PC), data server, kiosk, or portable device. The portable device may include a laptop computer, mobile phone, smartphone, tablet PC, mobile Internet device (MID), personal digital assistant (PDA), enterprise digital assistant (EDA), digital still camera, digital video camera, portable multimedia player (PMP), portable navigation device (PND), handheld game console, e-book, or a smart device such as a smart watch, smart band, or smart ring.

The customized service providing apparatus 10 may utilize an artificial intelligence model to process content extension. The artificial intelligence model may refer to a computer system having functions such as learning, reasoning, or decision-making, and may be implemented using a neural network.

The neural network may include artificial neurons (nodes) forming a network by synaptic connections and may have problem-solving capability through modification of synaptic weights during learning. The neural network may include a combination of weights and biases and may consist of one or more layers including one or more neurons or nodes. The neural network may infer a desired result from arbitrary input data by adjusting the weights through training.

The neural network may include a deep neural network (DNN). The neural network may include, for example, a convolutional neural network (CNN), a recurrent neural network (RNN), a perceptron, a multilayer perceptron (MLP), a feed forward (FF) network, a radial basis network (RBF), a deep feed forward (DFF) network, a long short term memory (LSTM) network, a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural Turing machine (NTM), a capsule network (CN), a Kohonen network (KN), a transformer, and an attention network (AN).

The neural network may include a generative artificial intelligence (AI). The generative AI may include a foundation model, and the foundation model may include a large language model (LLM).

The customized service providing apparatus 10 may train an artificial intelligence algorithm to extend content.

The customized service providing apparatus 10 may transmit and receive data with a user terminal 30 and/or a playback device 50. The customized service providing apparatus 10 may provide a customized service to a user using service information, meta information, and/or content fingerprint information stored in a database.

The playback device 50 may include a display. The display may visually output information and may include an LCD, electronic paper, LED display, OLED display, plasma display, stereoscopic display, holographic display, volumetric display, and/or projector.

The playback device 50 may include a printed circuit board such as a motherboard, an integrated circuit (IC), or a system-on-chip (SoC), and may include an application processor.

The playback device 50 may also be implemented as a PC, data server, kiosk, or portable device. The portable device may be implemented as a laptop computer, mobile phone, smartphone, tablet PC, mobile Internet device (MID), PDA, EDA, digital still camera, digital video camera, PMP, PND, handheld game console, e-book, or smart device such as a smart watch, smart band, or smart ring.

The customized service providing apparatus 10 may include a processor 100 and a memory 200. The customized service providing apparatus 10 may further include a transceiver. The transceiver may include a transmission interface and a reception interface and may include a communication module for transmitting data externally. The transceiver may receive data from an external source or from the memory 200 and may output the received data to the processor 100.

The user terminal 30 may include a capturing device. The capturing device may be implemented by a plurality of image sensors, each capable of sensing light and generating an electrical signal. The capturing device may generate an image based on sensing results and output the generated image to the processor 100.

The processor 100 may process data stored in the memory 200 and execute computer-readable instructions stored in the memory 200. The processor 100 may be implemented as a hardware data processing device having a circuit structure for executing desired operations. Examples of such hardware data processing devices include a microprocessor, a central processing unit (CPU), a processor core, a multi-core processor, a multiprocessor, an application-specific integrated circuit (ASIC), or a field-programmable gate array (FPGA).

The processor 100 may exchange data with a playback device 50 that is physically separated from the customized service providing apparatus 10. The playback device 50 may be external to the customized service providing apparatus 10 and there may be a plurality of playback devices 50.

The processor 100 may receive, from the user terminal 30 of a user to be provided with the customized service, an image including content and service information requested by the user. The image may include an image captured by a capturing device of the user terminal 30 or a separate capturing device.

The processor 100 may identify the content from the image based on content fingerprint information generated corresponding to the content in order to identify the content.

The fingerprint information may include a still cut of the content, a pixel distribution of a frame constituting the content, an outline of the frame, a shape of an object included in the frame, a size of the frame, or a variation trend of data amount of the frame over time of the content. The pixel distribution may include brightness and RGB distribution of pixels. The outline of the frame may include an outline of an object (for example, an organism or an inanimate object) included in the frame. Additionally, the fingerprint information may include audio signals or spectral information of the audio signal included in the content.

The processor 100 may calculate at least one of a degree of matching between the image and the pixel distribution of the frame, a degree of matching between the image and the outline of the frame, a degree of matching between the image and the shape of an object included in the frame, or a degree of matching between the image and a variation trend of data amount of the frame over time.

The processor 100 may identify the content based on whether at least one of the degree of matching between the image and the pixel distribution of the frame, the degree of matching between the image and the outline of the frame, the degree of matching between the image and the shape of an object included in the frame, and/or the degree of matching between the image and the variation trend of data amount of the frame over time is equal to or greater than a predetermined degree of matching.

The identification of the content may include searching for an original content, identifying whether the content including the image is an original content, and/or identifying a source of the content.

For example, when at least one of the degree of matching of pixel distribution, the degree of matching of outline, the degree of matching of object shape, and/or the degree of matching of variation trend of data amount is equal to or greater than a predetermined degree of matching, the processor 100 may identify that the content including the image captured by the user terminal 30 is the original content.

The processor 100 may acquire meta information corresponding to a frame constituting the content based on the image. The meta information may include a shooting location of the frame of the content, a title of the content, a producer of the content, a playback time of the content, a resolution of the content, a file size, playback progress of the content, person information included in the frame, or product information included in the frame.

The processor 100 may provide a service requested by the user based on the meta information. The processor 100 may obtain modified information derived from an original of the content based on the meta information.

The processor 100 may provide the modified information to the user in response to the service information requested by the user.

The modified information may include editing information of an image of the original, editing information of subtitles corresponding to the original, editing information of an audio signal of the original, and information indicating whether the image is an original.

The processor 100 may determine whether the image is a part of an original content based on the meta information in response to the service information requested by the user, and may determine whether the image constitutes a copyright infringement based on whether the image is a part of the original content.

The memory 200 may store data for operations performed by the processor 100 or store results of operations of the processor 100. The memory 200 may store instructions (or programs) executable by the processor 100. For example, the instructions may include instructions for executing operations of the processor 100 and/or operations of each component of the processor 100.

The memory 200 may be implemented as a volatile memory device or a nonvolatile memory device.

The volatile memory device may be implemented as a dynamic random access memory (DRAM), a static random access memory (SRAM), a thyristor RAM (T-RAM), a zero capacitor RAM (Z-RAM), or a twin transistor RAM (TTRAM).

The nonvolatile memory device may be implemented as an electrically erasable programmable read-only memory (EEPROM), a flash memory, a magnetic RAM (MRAM), a spin-transfer torque magnetic RAM (STT-MRAM), a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, or an insulator resistance change memory.

The memory 200 may include a database for storing content fingerprint information, meta information, and/or service information corresponding to content.

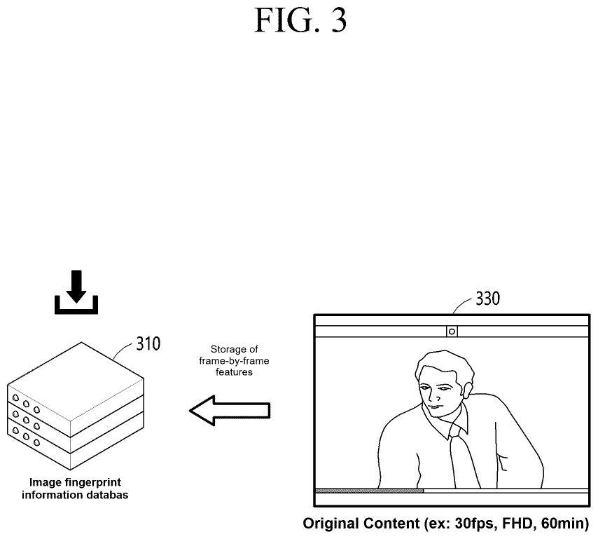

FIG. 3 is a diagram for explaining a process of generating fingerprint information of an image according to one embodiment.

Referring to FIG. 3, a processor (for example, the processor 100 of FIG. 2) may identify content from an image based on fingerprint information generated corresponding to the content in order to identify the content. The processor 100 may generate the fingerprint information and store it in a database 310 of a memory (for example, the memory 200 of FIG. 2).

The processor 100 may obtain content 330 that is stored by a user or obtained from a user terminal. The content 330 may include a video or an image. The processor 100 may generate fingerprint information by using the obtained video or image. The processor 100 may extract, from the received video or image, information such as pixel distribution per frame of the video, outline information, still-cut information, information regarding a shape of an object included in the video or image, and variation of data amount of the frame or image, and store the extracted information in the database.

The processor 100 may also store, in the database, audio information and/or subtitle information for each timeline.

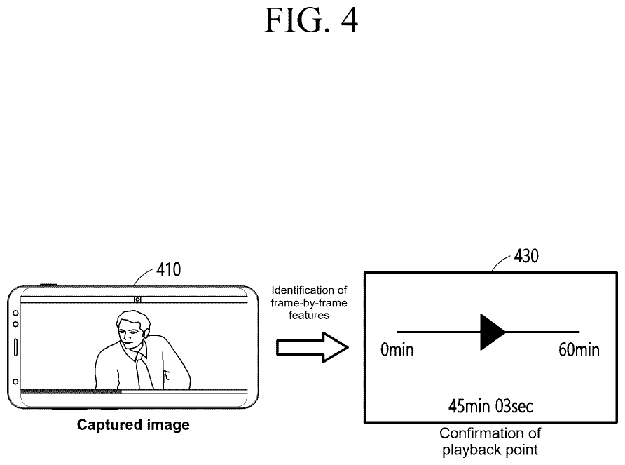

FIG. 4 is a diagram for explaining an operation of confirming a playback point of content based on fingerprint information generated according to one embodiment.

Referring to FIG. 4, a processor (for example, the processor 100 of FIG. 2) may confirm a playback point 430 based on frame features of a captured image 410 received from a user terminal. The frame features may include fingerprint information.

The processor 100 may receive, from the user terminal, the captured image 410 that captures a video or an image displayed on a separate playback device. When content is being played on the user terminal, the processor 100 may identify fingerprint information of the content being played on the user terminal in response to any input signal (for example, a touch signal or a button press) generated from the user terminal.

Based on the database in which fingerprint information is stored, the processor 100 may specify a playback point 430 of the content and identify meta information corresponding to the specified playback point 430, based on RGB distribution information per frame of the video, outline (contour) information, still-cut information, object shape information, pixel brightness distribution information, and average data amount per frame.

When the meta information is identified, the processor 100 may transmit the meta information to the user terminal, and the user may change the playback point 430 of the video or change the playback device by operating the user terminal.

For example, the user terminal or the playback device may provide the user with a rewind function or a resume function by using the playback point 430 provided by the processor 100.

The processor 100 may determine a playback point 430 of content by capturing an image or a video reproduced through a playback device (for example, a TV or other display device) or by responding to a touch on the display, and may provide the user with information related to the playback point 430 or provide the user with a resume or rewind function from the determined playback point 430.

In response to capturing an image or video being reproduced or touching the display, the processor 100 may identify, from a database of a server, information such as RGB distribution per frame, outline information, still-cut information, object shape information, pixel information, and average data amount per frame, and may specify meta information and a playback point 430 of the currently reproduced content. The processor 100 may perform a function of resuming or rewinding playback on another display device based on a specific playback point 430.

During image capturing using a capturing device, the processor 100 may continuously verify whether the content reproduced by one playback device matches the content reproduced by another playback device. The processor 100 may check content matching at a predetermined period, and when it is confirmed that different content is being reproduced from at least one playback device, the processor 100 may synchronize and reproduce the different content.

The processor 100 may divide the reproduced video into a plurality of regions, and may search for the content by comparing some of the divided regions with content in the database. In addition, when the captured image is taken at an angle unsuitable for searching (for example, an angle perpendicular or parallel to the shooting plane), the processor 100 may correct the angle of the captured image and then search for the content.

The processor 100 may search for the content based on the position of subtitles.

The processor 100 may provide a communication function between a user (for example, a customer or a partner) of the customized service providing apparatus 10 and characters or actors appearing in the content, in response to photographing the content being played as an image or to touching the display on which the content is being played.

The processor 100 may determine a timeline based on meta information by treating images related to the content, such as still cuts of the content, as frames of a video and processing them in the same manner as video frames, and may provide a customized service based thereon.

While receiving a video from the user terminal in real time, the processor 100 may identify whether the content reproduced by the playback device matches the content at a predetermined period. When the processor 100 detects a change of content, the processor 100 may newly search for the content based on new fingerprint information.

Even when only a part of a frame constituting the content is received, the processor 100 may search for the content. For example, the processor 100 may identify original content based on a cropped frame or a frame in which a subtitle portion is cut. In such a case, as described above, the processor 100 may identify the content based on at least one of a still cut of the content, a pixel distribution of a frame constituting the content, an outline of the frame, a shape of an object included in the frame, a size of the frame, or a variation trend of data amount of the frame over time of the content.

The processor 100 may divide the received captured image 410 into a plurality of regions and may identify the content based on fingerprint information corresponding to the divided regions.

The processor 100 may perform preprocessing to facilitate identification by rotating the received captured image 410 or adjusting its perspective.

For example, when the captured image 410 taken by the user terminal is not taken perpendicularly, the processor 100 may rotate the image to correct it perpendicularly and then extract fingerprint information.

When subtitles are included in the content, the processor 100 may extract fingerprint information by including the subtitles in the image, or may extract fingerprint information based on the image in which the subtitles are removed. The processor 100 may also use recognized text of subtitles as fingerprint information.

In the case of content including subtitles, the processor 100 may assume that the subtitle portion is in the same position in the database stored in the server, and may compare them accordingly to improve the speed of content identification.

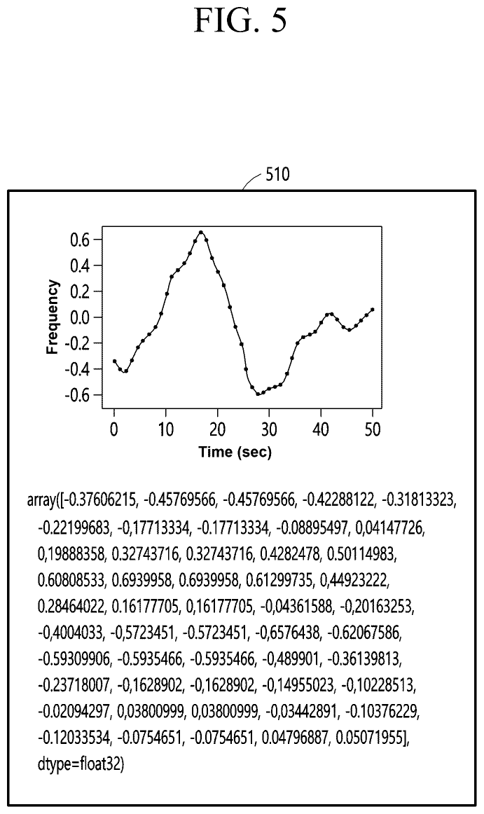

FIG. 5 illustrates an example of a variation trend of data values for respective frames.

Referring to FIG. 5, a processor 100 may extract a variation trend of data amount of frames of content and store the variation trend in a database. The processor 100 may store, in the database, variations in data amount per frame (or, differences in data amount between frames).

FIG. 5 is plot 510 that visualizes the speed of the temporal patterns contained within the signal of variation—that is, the frequency at which the changes are repeated.

The processor 100 may grasp a variation trend of data amount while continuously receiving images from a user terminal over time. The processor 100 may receive an image at a predetermined period or may receive a video from the user terminal and obtain a plurality of images in a form of sampling frames at the predetermined period.

The processor 100 may confirm a timeline by continuously comparing a variation trend of data amount of frames with a variation trend of data amount of original content stored in the database.

The processor 100 may identify content based on variations in pixel distribution of a plurality of images received.

The processor 100 may identify content by grasping variations in pixel distribution of images captured at a plurality of time points and by comparing and contrasting the variations with variations in pixel distribution of frames of the original content previously stored in the database.

The processor 100 may grasp a timeline of content by using variations in data amount or variations in pixel distribution and may obtain meta information corresponding thereto.

The processor 100 may store different variation trends of data amount according to the resolution of the content. For example, when the resolution of the content differs, such as 720p, 1080p, or 2160p, by separately storing variations in data amount according to the resolution in the database, the processor 100 may identify a resolution of the image captured by a user or content included in the image, and may identify the content by using fingerprint information corresponding to the identified resolution.

The processor 100 may extract only outline information of a captured image (for example, an outline of an object included in the image or an outline of the image itself) and may identify the content based on a variation trend of data of the outline or a variation trend of pixels of the outline.

Through the above-described process, the processor 100 may grasp which playback point image captured by the user terminal corresponds to in the original content and may provide playback point information to the user terminal so that the user may continue viewing the content based on the identified playback point. The processor 100 may provide, to the user terminal, person information and product information included in a frame corresponding to the playback point.

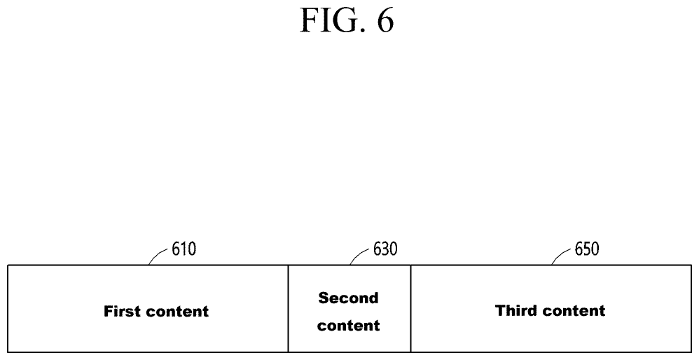

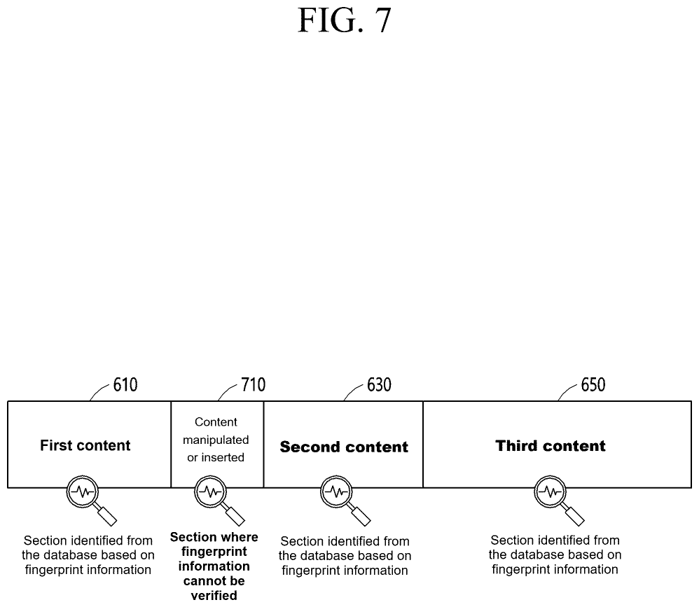

FIGS. 6 and 7 are diagrams for explaining an operation in which the customized service providing apparatus illustrated in FIG. 1 determines whether copyright infringement has occurred.

Referring to FIGS. 6 and 7, a processor (for example, the processor 100 of FIG. 2) may determine, based on identified content information, whether content captured by a user terminal infringes the copyright of an original content.

When a plurality of contents (for example, a first content 610, a second content 630, and a third content 650) are edited and combined to form new content, the processor 100 may identify each original content and provide corresponding meta information to the user terminal.

The processor 100 may extract fingerprint information corresponding to each content from images capturing the first content 610, the second content 630, or the third content 650, and may identify the original content based on the extracted fingerprint information.

The processor 100 may identify a copyright holder of each original content and may allocate revenue to the identified copyright holder.

The processor 100 may allocate revenue to a plurality of copyright holders based on playback times of the respective contents.

The processor 100 may allocate revenue to copyright holders or advertisers related to respective contents based on product information included in the plurality of contents, exposure times of products combined with advertisements, and playback times of the respective contents.

For example, as illustrated in FIG. 6, when three contents are combined to form new content, the processor 100 may determine playback times of the first content 610, the second content 630, and the third content 650, and may allocate revenue to copyright holders of the respective contents in proportion to the playback time ratio.

The processor 100 may allocate revenue to a plurality of advertisers based on the number of advertised products included in the first content 610, the second content 630, and the third content 650, the prices of the advertised products, and the set advertising cost. The processor 100 may set a first weight corresponding to the number of products, a second weight corresponding to the price of the advertised product, and a third weight corresponding to the set advertising cost. The processor 100 may determine a revenue ratio by applying the first weight, the second weight, and the third weight. For example, the processor 100 may determine the revenue ratio using a value obtained by multiplying the first weight by the number of products, multiplying the second weight by the price of the advertised product, and multiplying the third weight by the set advertising cost and summing the multiplied values.

When reproducing content in which contents of a plurality of copyright holders are mixed, the processor 100 may separately extract fingerprint information corresponding to each content and may identify each content. The user may easily identify the original content by receiving the identified content information.

When content different from the original content created by the copyright holder is included, the processor 100 may provide modified information to the user.

The processor 100 may provide the modified information to the user in response to service information requested by the user. The modified information may include editing information of an image of the original, editing information of subtitles corresponding to the original, editing information of an audio signal of the original, and information indicating whether the image is an original.

When all or part of the content is modified content that is not the original content created by the copyright holder, the processor 100 may inform the user that the content is unverified content.

When the processor 100 receives a captured image of content having a playback speed different from that of the original, the processor 100 may change the playback speed to synchronize it with the playback speed of the original content. For example, when content whose playback speed is adjusted to 1.5 times or 2 times is captured and received through the user terminal, the processor 100 may change the playback speed to the original playback speed and then extract fingerprint information.

The processor 100 may determine whether the content captured by the user terminal has been manipulated based on fingerprint information. The processor 100 may provide manipulation information to the user for the content in which manipulation has been confirmed.

The processor 100 may continuously check frame changes of images or videos captured through the user terminal. The processor 100 may determine whether the content has been manipulated based on frame changes.

In addition, when new content formed based on fingerprint information is generated by editing original content, the processor 100 may provide, to the user terminal, information on playback points of the edited portions, an amount of edited information, a length of the edited content, or added information.

When some items have been modified, such as when the original content does not include subtitles but the newly edited content includes subtitles, the processor 100 may provide the user with an indication showing differences from the original content, for example, “original comparison video (O), audio (O), subtitles (X).”

The processor 100 may exceptionally change the notation of information provided for subtitles. For example, when only subtitle information has been added to the content, the processor 100 may handle it as an exception, display a notation such as “Copyright,” and provide a separate indication to allow the user to recognize that subtitles have been inserted.

When the processor 100 receives a captured image related to content that is different from but similar to the original content and identifies the similar content, the processor 100 may provide a user with differences between the original content and the similar content by displaying outlines (for example, drawing contours, subtitles, or outlines) constituting the original content.

When content 710 in which fingerprint information cannot be verified is inserted into newly created content, the processor 100 may specify a playback point of the unverifiable content 710 and may register fingerprint information of the new content into the database as new content.

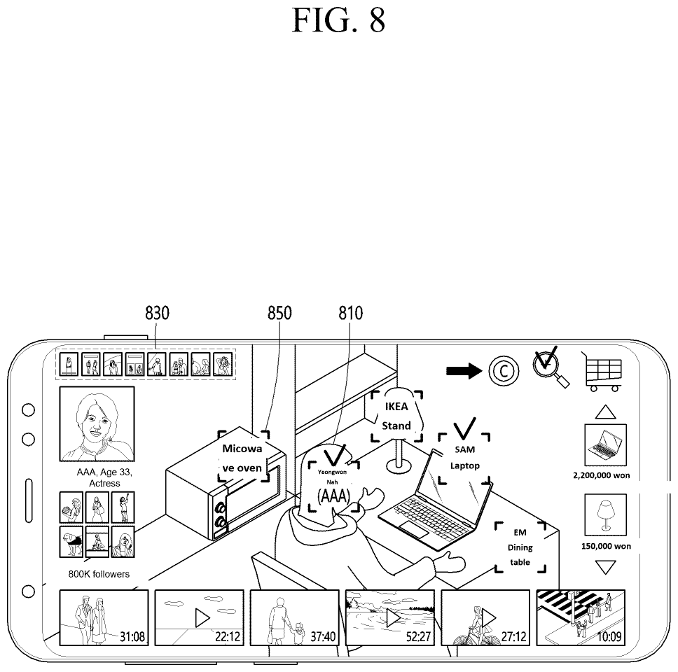

FIG. 8 illustrates an example of services provided by the customized service providing apparatus illustrated in FIG. 1.

Referring to FIG. 8, a processor (for example, the processor 100 of FIG. 2) may provide a service requested by a user based on meta information.

The processor 100 may provide person information 810 included in identified content. The processor 100 may provide, through a display of the user terminal, a detailed page 830 of product information or person information.

The processor 100 may provide information on a product or a person included in the content in response to a user's touch on the display of the user terminal.

The processor 100 may provide information on whether damage or alteration from the original has occurred in response to a touch on the screen. When the content being reproduced through a current playback device or user terminal is not the original, the processor 100 may provide, to the user terminal or playback device, information on the source and playback point of the original so that the original can be played continuously.

The processor 100 may differentiate non-original content from original content by displaying, only for the original content, person information or product information and/or location information extracted from meta information.

The processor 100 may directly provide a product purchase service through the user terminal. For example, when a user touches a product image 850, the processor 100 may respond thereto and allow direct access, through the user terminal, to a purchase page of the touched product.

When the user purchases a product, the processor 100 may allocate generated revenue to an advertiser. The processor 100 may allocate revenue generated through advertisement traffic to an advertiser or a copyright holder.

The processor 100 may provide revenue information related to content to the advertiser or copyright holder. The processor 100 may provide the advertiser or copyright holder with information regarding sections where revenue is generated from the content, duration of time users stay in the content, frequency of content use, and traffic information of access to the content.

When advertisements are provided based on customer traffic of the original content, the processor 100 may adjust a revenue allocation ratio so that advertisement revenue can be shared between a streaming entity reproducing the advertisement and the advertiser.

The processor 100 may display a plurality of items of information on a single screen.

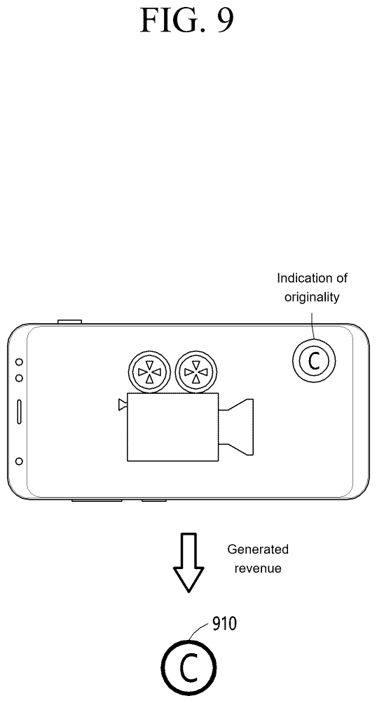

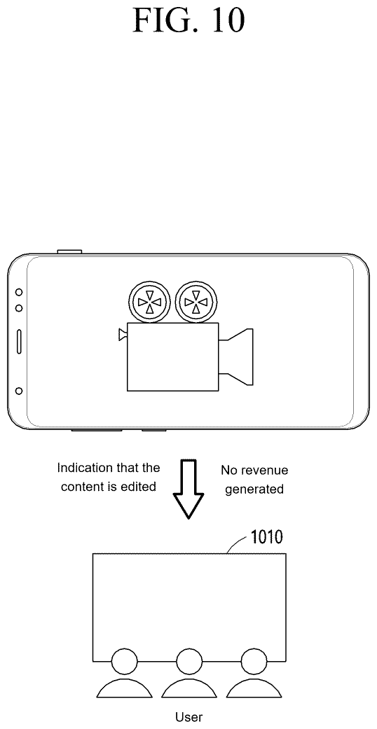

FIGS. 9 and 10 are diagrams for explaining a process in which the customized service providing apparatus illustrated in FIG. 1 allocates revenue to an advertiser or a copyright holder.

Referring to FIGS. 9 and 10, a processor (for example, the processor 100 of FIG. 2) may allocate revenue to a revenue subject 910. For example, the revenue subject may include a copyright holder or an advertiser.

The processor 100 may identify whether an advertiser or a copyright holder related to service information exists in response to service information requested by a user. When the advertiser or the copyright holder exists, the processor 100 may allocate predetermined revenue to the advertiser or the copyright holder.

The processor 100 may identify whether an advertiser or a copyright holder related to service information requested by a user 1010 exists.

When the advertiser or the copyright holder exists, the processor 100 may allocate predetermined revenue to the advertiser or the copyright holder.

When the user 1010 purchases a product based on meta information of content or generates advertisement traffic, the processor 100 may allocate revenue to the copyright holder or the advertiser. When the content is identified as edited content, the processor 100 may not allocate revenue to a copyright holder or an editor of the edited content.

For newly generated content created by editing an original content or for content in which only a part has been edited, the processor 100 may separately indicate the edited content and the original content and may allocate revenue to the copyright holder of the original content.

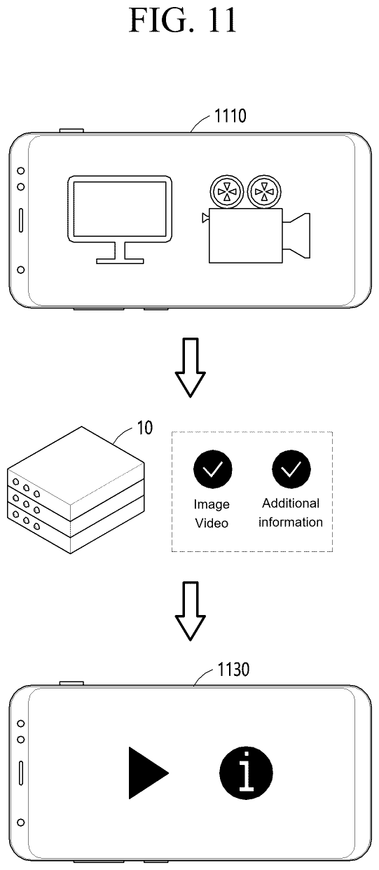

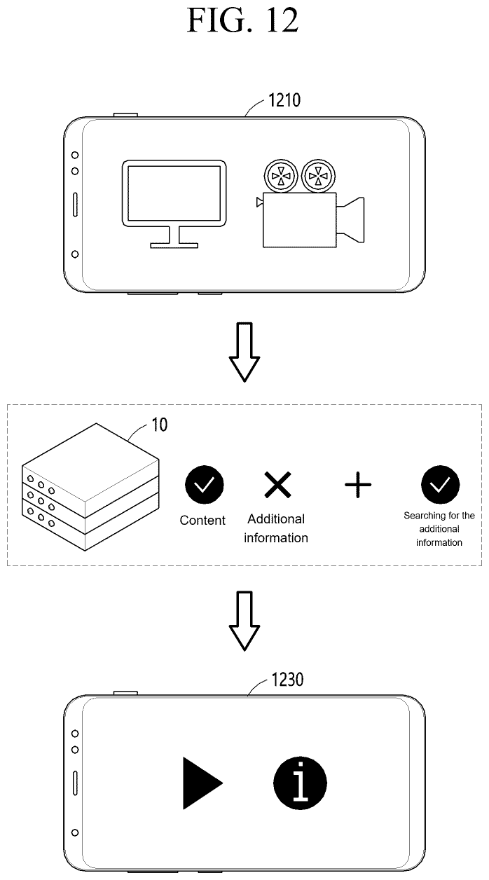

FIG. 11 illustrates an example of a service providing operation of the customized service providing apparatus illustrated in FIG. 1 when additional information related to content is stored, and FIG. 12 illustrates an example of a service providing operation of the customized service providing apparatus illustrated in FIG. 1 when additional information related to content is not stored.

Referring to FIGS. 11 and 12, a processor (for example, the processor 100 of FIG. 2) of the customized service providing apparatus 10 may provide a customized service to a user based on meta information corresponding to identified content.

The processor 100 may receive an image capturing content reproduced from a playback device or content reproduced from a user terminal 1110, identify original content, and confirm a timeline.

When the content is identified, the processor 100 may determine whether meta information related to the original content exists in a database. The processor 100 may grasp a frame being viewed by the user based on the confirmed timeline and may provide meta information related thereto to the user. For example, the processor 100 may provide, to the user, location information on a current frame, information on a product included in the current frame, and information on a person.

The processor 100 may transmit the extracted meta information to a terminal 1130 different from the user terminal 1110 that transmitted the image.

When no meta information stored in the database exists, the processor 100 may perform a search through a search engine for a product or a person that a user has touched or dragged (for example, a motion of drawing a circle around a product or person) on a user terminal 1210, and may provide the search result to the user terminal 1210 or 1230.

The processor 100 may additionally store the once-provided search result in the database as meta information. Alternatively, the processor 100 may store meta information provided by the user in the database. The processor 100 may modify or add meta information stored in the existing database based on information provided by the user or search results.

The meta information may further include information on a person, product, location, background music, cultural background, fashion, trend, historical period, and/or related historical information.

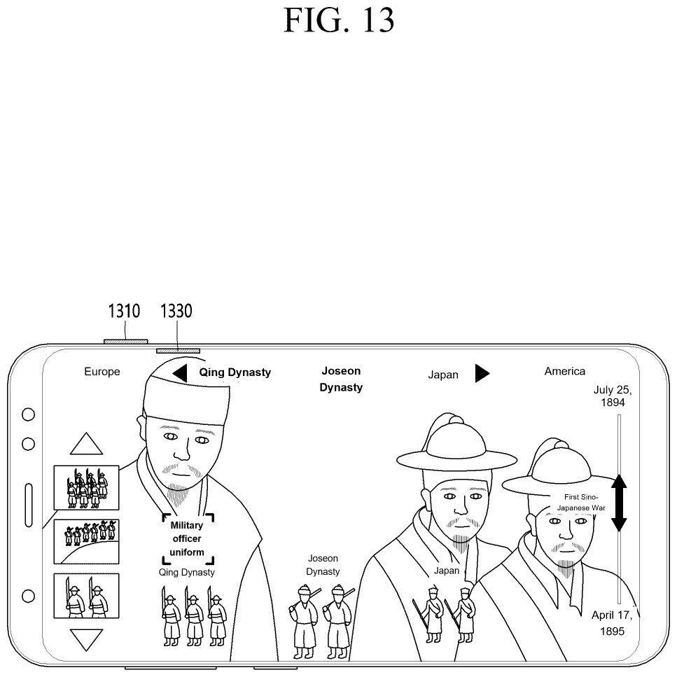

FIG. 13 illustrates an example of a synchronization service provided by the customized service providing apparatus illustrated in FIG. 1.

Referring to FIG. 13, a processor (for example, the processor 100 of FIG. 2) may identify content and a timeline of the content through the above-described process.

The processor 100 may synchronize a playback point of the content with a user terminal or a playback device by transmitting the identified timeline to the user terminal or the playback device.

The processor 100 may transmit a playback point to the user terminal in response to pressing of a first button 1310 or a second button 1330 of the user terminal, and the user terminal may synchronize a playback point with original content based on the transmitted playback point.

The first button 1310 may be a physical button, and the second button 1330 may be a software button.

The processor 100 may perform synchronization of the playback point based on sound information. When a playback point can be directly received from streaming software used by the user terminal or the playback device, synchronization of the playback point may be performed between the user terminal and the playback device without passing through the customized service providing apparatus 10.

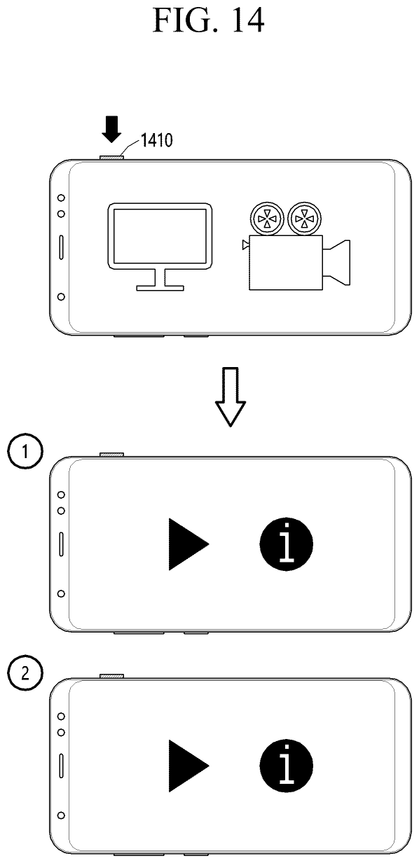

FIG. 14 illustrates another example of a synchronization service provided by the customized service providing apparatus illustrated in FIG. 1.

Referring to FIG. 14, a processor (for example, the processor 100 of FIG. 2) may provide product information to a user terminal in response to pressing of a first button 1410. When the first button 1410 is pressed, the processor 100 may identify content through fingerprint information of the content being reproduced on the user terminal, and may search meta information of a database based on the identified content and provide it to the user terminal.

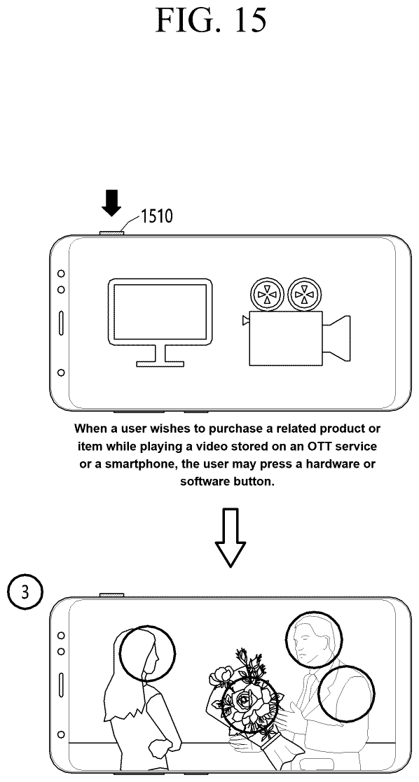

FIG. 15 illustrates yet another example of a synchronization service provided by the customized service providing apparatus illustrated in FIG. 1.

Referring to FIG. 15, when meta information is not stored in the database or fingerprint information does not exist, a processor (for example, the processor 100 of FIG. 2) may search, through a search engine, product or person information included in the content reproduced on the user terminal in response to pressing of a first button 1510 and may provide the search results to the user.

The processor 100 may process information marked by timeline and may display the overall information or display the information collected by section (by chapter).

The processor 100 may provide different meta information depending on a user. For example, the processor 100 may generate and provide customized information by using a user's search history, a user's location, a user's Internet page visit history, and a user's purchasing pattern.

The processor 100 may obtain answers from other users to queries for unregistered meta information and may update the database with the obtained meta information. Through this, a user of the customized service providing apparatus 10 may obtain necessary information without using other programs.

The processor 100 may provide an editing interface capable of editing information on products, places, and persons appearing in content to a user, an advertiser, and/or a copyright holder.

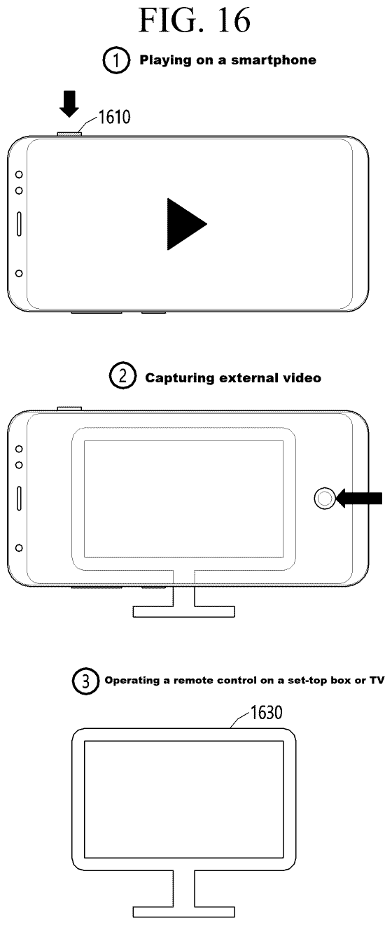

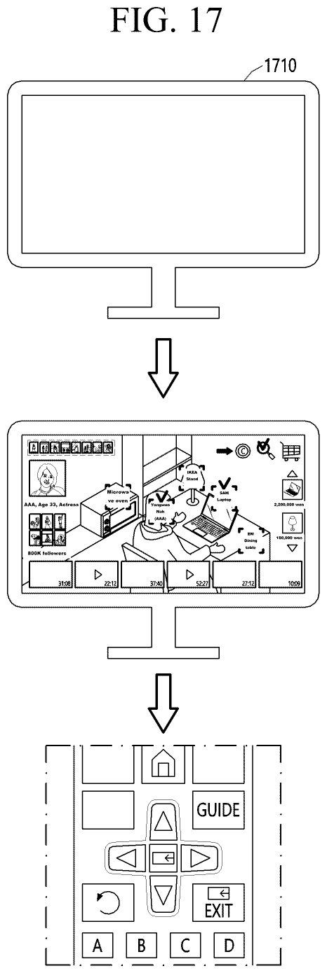

FIG. 16 illustrates an example of a service of providing product information by the customized service providing apparatus illustrated in FIG. 1, and FIG. 17 illustrates an operation in which the customized service providing apparatus illustrated in FIG. 1 provides a service in association with a playback device.

Referring to FIGS. 16 and 17, when content is being reproduced on a user terminal (for example, a smartphone), a processor (for example, the processor 100 of FIG. 2) may provide meta information (for example, product information or person information) related to the content to the user terminal in response to pressing of a physical button 1610.

The processor 100 can capture an image played on an external playback device such as a TV 1630 and remotely control the TV 1630.

The processor 100 may also provide a customized service by using a remote-control button serving as a trigger for controlling an external playback device 1710.

The processor 100 may identify the content based on fingerprint information of the content being reproduced by the playback device in response to pressing of the remote-control button, and may output corresponding meta information through the playback device.

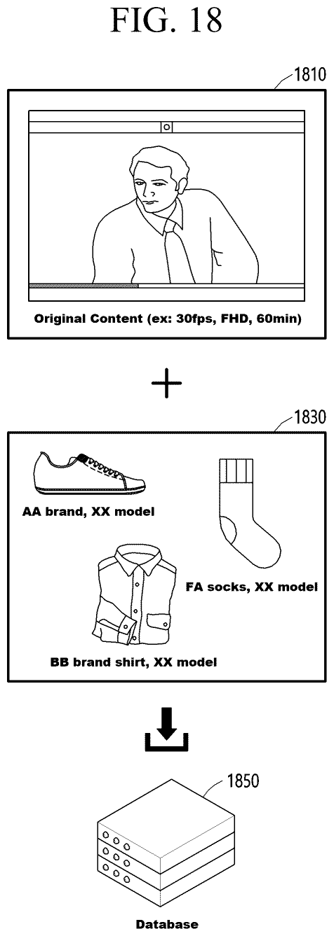

FIG. 18 illustrates a process in which the customized service providing apparatus illustrated in FIG. 1 generates service information associated with content.

Referring to FIG. 18, a processor (for example, the processor 100 of FIG. 2) may provide a user with an input interface for updating meta information 1830. The processor 100 may store meta information 1830 corresponding to a frame 1810 in a database 1850.

For example, the processor 100 may search, from the database, for images related to products, persons, or places that are already known, and may link meta information such as a product name, an original photo, and price information to a frame (or timeline) appearing in fingerprint information.

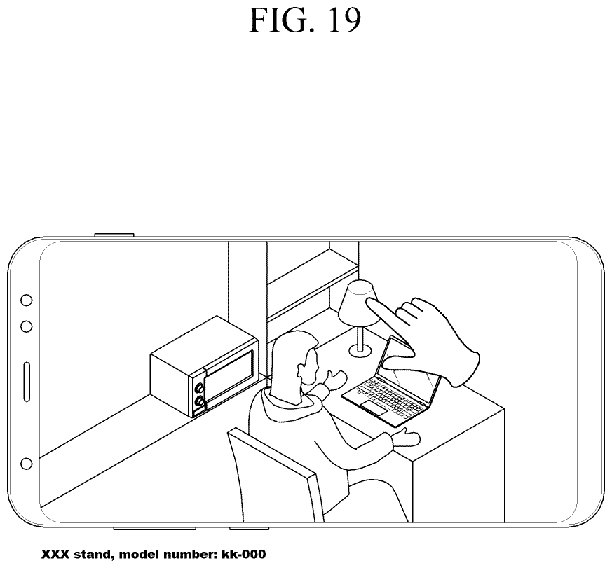

FIG. 19 is a diagram for explaining an operation of providing different input interfaces depending on types of users.

Referring to FIG. 19, a processor 100 may provide different interfaces depending on types of users. For example, when a user is a member registered as a business operator, the processor 100 may collectively organize and provide meta information about products related to the business operator. The processor 100 may provide an input interface capable of updating meta information regarding goods related to the business operator.

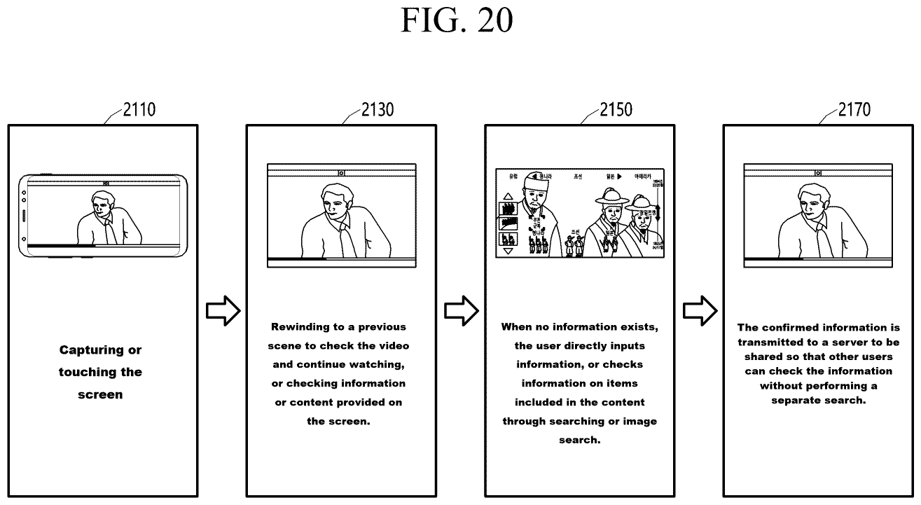

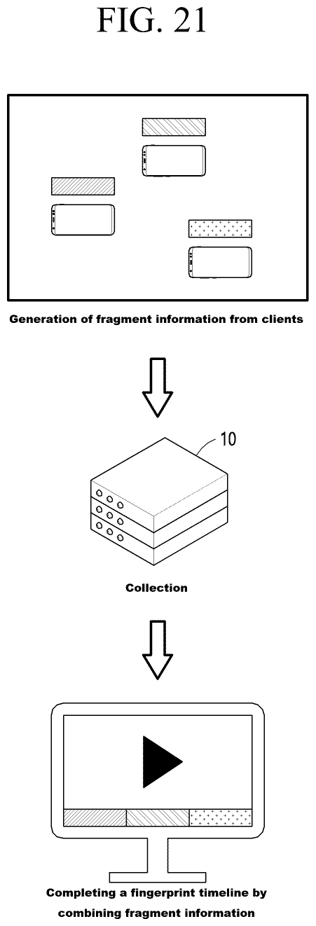

FIGS. 20 and 21 are diagrams for explaining an operation of updating fingerprint information and meta information through a plurality of users.

Referring to FIGS. 20 and 21, when a processor 100 of the customized service providing apparatus 10 fails to identify content from a database or when meta information does not exist, the processor 100 may extract fingerprint information from a plurality of user terminals and may register content and meta information in real time.

The processor 100 may extract fingerprint information based on images or videos received from a plurality of user terminals, combine the extracted fingerprint information, complete fingerprint information about the content, and store it in the database.

When a user performs photographing or information marking while viewing content for which fingerprint information is not stored in the database, the processor 100 may combine the information and complete the fingerprint information.

When a user photographs a playback device reproducing content or touches a screen during playback of content, the processor 100 may identify the content in response thereto (2110).

Based on the identified content and a timeline of a captured frame, the processor 100 may allow the user to rewind to a previous scene or provide the user with meta information (for example, product information or person information) corresponding to the frame (2130).

When meta information does not exist, the processor 100 may provide an input interface to the user (2150). The processor 100 may store meta information input by the user in the database and may also store search results from an Internet search engine in the database.

The processor 100 may share updated meta information with a plurality of users (2170).

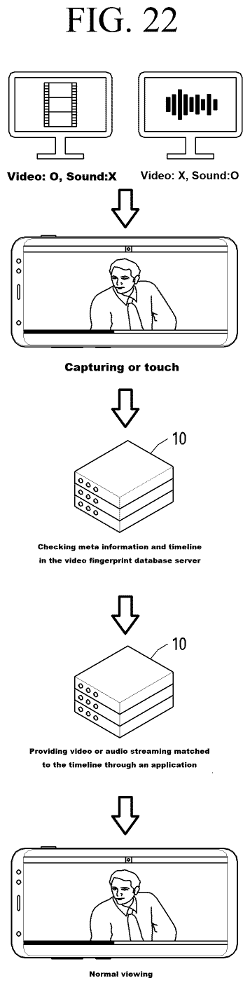

FIG. 22 is a diagram illustrating an operation in which the customized service providing apparatus illustrated in FIG. 1 supports playback of content.

Referring to FIG. 22, when a user terminal or a playback device cannot output audio or an image because a specific codec is not supported, a processor (for example, the processor 100 of FIG. 2) of the customized service providing apparatus 10 may search for original content existing in a database and may perform streaming service or codec support so that the user terminal or playback device can reproduce the content in a playable format.

For example, when the user terminal does not support audio, the processor 100 may identify a timeline through fingerprint information and synchronize audio signals stored in the database with the user terminal to provide them. Similarly, when the user terminal does not support video, the processor 100 may identify a timeline through fingerprint information and synchronize video stored in the database with the user terminal to provide it.

Through this, the processor 100 may support a user in normally viewing the content.

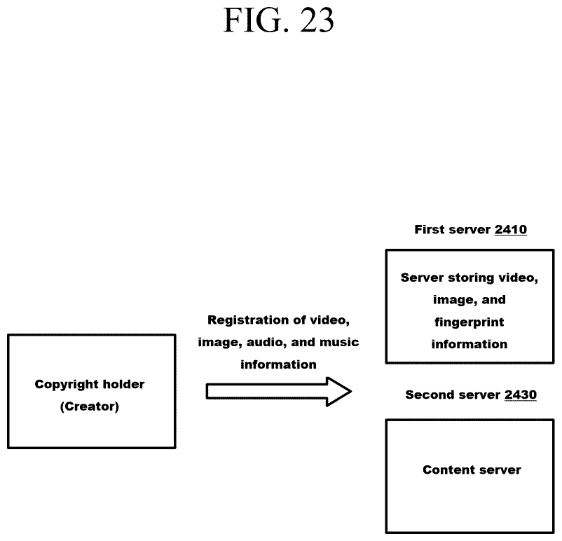

FIG. 23 illustrates an example of a method for managing service information by the customized service providing apparatus illustrated in FIG. 1.

Referring to FIG. 23, the customized service providing apparatus (for example, the customized service providing apparatus 10 of FIG. 1) may be implemented with a plurality of servers. The plurality of servers may include a first server 2410 and a second server 2430. The first server 2410 may be a server that stores fingerprint information, video, and images. The second server 2430 may be a server that stores content.

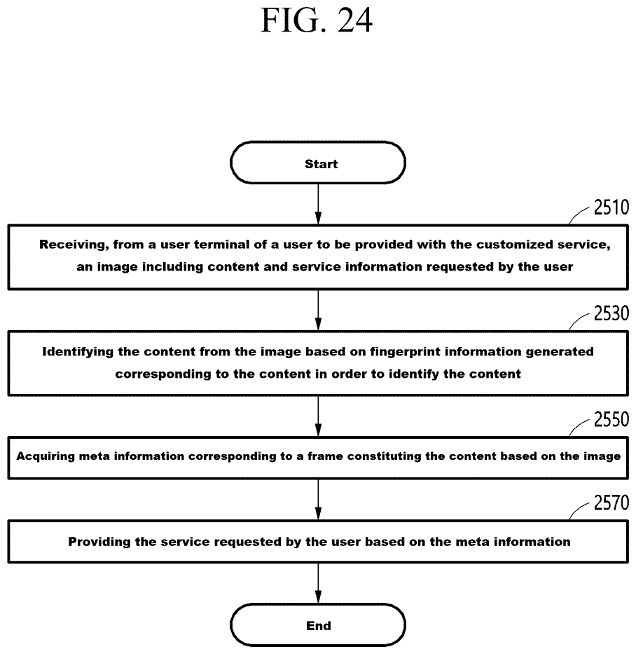

FIG. 24 is a flowchart illustrating an operation of a content expansion apparatus illustrated in FIG. 1.

Referring to FIG. 24, a processor (for example, the processor 100 of FIG. 2) may receive, from a user terminal of a user to be provided with a customized service, an image including content and service information requested by the user (2510).

The processor 100 may identify the content from the image based on fingerprint information generated corresponding to the content in order to identify the content (2530).

The fingerprint information may include a still cut of the content, a pixel distribution of a frame constituting the content, an outline of the frame, a shape of an object included in the frame, a size of the frame, or a variation trend of data amount of the frame over time of the content. The pixel distribution may include brightness and RGB distribution of pixels.

The processor 100 may calculate at least one of a degree of matching between the image and the pixel distribution of the frame, a degree of matching between the image and the outline of the frame, a degree of matching between the image and the shape of an object included in the frame, or a degree of matching between the image and a variation trend of data amount of the frame over time.

The processor 100 may identify the content based on whether at least one of the degree of matching between the image and the pixel distribution of the frame, the degree of matching between the image and the outline of the frame, the degree of matching between the image and the shape of an object included in the frame, and/or the degree of matching between the image and the variation trend of data amount of the frame over time is equal to or greater than a predetermined degree of matching. The identification of the content may include searching for an original content, identifying whether the content including the image is an original content, and/or identifying a source of the content.

The processor 100 may identify the content based on whether at least one of the degree of matching between the image and the pixel distribution of the frame, the degree of matching between the image and the outline of the frame, the degree of matching between the image and the shape of an object included in the frame, or the degree of matching between the image and the variation trend of data amount of the frame over time is equal to or greater than a predetermined degree of matching.

The processor 100 may acquire meta information corresponding to a frame constituting the content based on the image (2550). The meta information may include a shooting location of the frame of the content, a title of the content, a producer of the content, a playback time of the content, a resolution of the content, a file size, playback progress of the content, person information included in the frame, or product information included in the frame.

The processor 100 may provide a service requested by the user based on the meta information (2570). The processor 100 may obtain modified information derived from an original of the content based on the meta information.

The processor 100 may provide the modified information to the user in response to service information requested by the user. The modified information may include editing information of an image of the original, editing information of subtitles corresponding to the original, editing information of an audio signal of the original, and information indicating whether the image is an original.

The processor 100 may determine whether the image is a part of an original content based on the meta information in response to service information requested by the user, and may determine whether the image constitutes a copyright infringement based on whether the image is a part of the original content.

The examples described herein may be implemented using hardware components, software components and/or combinations thereof. A processing device may be implemented using one or more of general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

Although the examples have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. An apparatus for providing a customized service using content fingerprint information, comprising:
a processor; and
a memory storing instructions executable by the processor,
wherein the processor is configured to:
receive, from a user terminal of a user to be provided with the customized service, an image including content and service information requested by the user;
identify the content from the image based on fingerprint information generated corresponding to the content in order to identify the content;
acquire meta information corresponding to a frame constituting the content based on the image; and
provide the service requested by the user based on the meta information.

2. The apparatus of claim 1,
wherein the fingerprint information includes at least one of a still cut of the content, a pixel distribution of a frame constituting the content, an outline of the frame, a shape of an object included in the frame, a size of the frame, or a variation trend of data amount of the frame over time of the content,
wherein the pixel distribution includes a brightness and RGB distribution of pixels.

3. The apparatus of claim 1,
wherein the processor is configured to:
calculate at least one of a degree of matching between the image and the pixel distribution of the frame, a degree of matching between the image and the outline of the frame, a degree of matching between the image and the shape of an object included in the frame, or a degree of matching between the image and a variation trend of data amount of the frame over time; and
identify the content based on whether at least one of the degrees of matching is equal to or greater than a predetermined degree of matching.

4. The apparatus of claim 1,
wherein the meta information includes at least one of a shooting location of the frame of the content, a title of the content, a producer of the content, a playback time of the content, a resolution of the content, a file size, playback progress of the content, person information included in the frame, or product information included in the frame.

5. The apparatus of claim 1,
wherein the processor is configured to:
obtain modified information derived from an original of the content based on the meta information; and
provide the modified information to the user in response to the service information requested by the user,
wherein the modified information includes at least one of editing information of an image of the original, editing information of subtitles corresponding to the original, editing information of an audio signal of the original, or information indicating whether the image is an original.

6. The apparatus of claim 1,
wherein the processor is configured to:
determine whether the image is a part of an original content based on the meta information in response to the service information requested by the user; and
determine whether the image constitutes a copyright infringement based on whether the image is a part of the original content.

7. The apparatus of claim 1,
wherein the processor is configured to:
identify whether an advertiser or a copyright holder associated with the service information requested by the user exists; and
allocate a predetermined revenue to the advertiser or the copyright holder when the advertiser or the copyright holder exists.
